(19) United States
(12) Patent Application Publication
(10) Pub. No.: US 2019/0214179 A1
(43) Pub. Date: Jul. 11, 2019

(54) A CORE ELEMENT FOR A MAGNETIC COMPONENT AND A METHOD FOR MANUFACTURING THE SAME

(71) Applicant: LAPPEENRANNAN TEKNILLINEN YLIOPISTO, Lappeenrannan (FI)

(72) Inventors: Olli PYRHÖNEN, LAPPEENRANTA (FI); Rafal Piotr JASTRZEBSKI, LAPPEENRANTA (FI); Antti SALMINEN, LAPPEENRANTA (FI); Jussi SOPANEN, LAPPEENRANTA (FI)

(21) Appl. No.: 16/325,616

(22) PCT Filed: Aug. 22, 2017
(86) PCT No.: PCT/FI2017/050586

§ 371 Date: Feb. 14, 2019

(30) Foreign Application Priority Data
Aug. 24, 2016 (FI) 20165628

(51) Int. Cl. H01F 27/245; H02K 1/16; H02K 1/26; H02K 15/02

(52) U.S. Cl. CPC H01F 27/245; H02K 15/02; H02K 1/26; H02K 1/16

(57) ABSTRACT

A core element for a magnetic component includes a plurality of ferromagnetic sections for conducting a magnetic flux. Adjacent ones of the ferromagnetic sections are connected to each other with ferromagnetic isthmuses keeping the adjacent ones of the ferromagnetic sections a distance apart from each other, and/or the gaps between the ferromagnetic sections are filled with electrically insulating solid material and adjacent ones of the gaps are connected to each other via openings through the ferromagnetic sections and filled with electrically insulating solid material. The ferromagnetic sections can constitute for example a stack of ferromagnetic sheets or a bundle of ferromagnetic filaments. The core element can be manufactured by three-dimensional printing and thus it is possible to make core elements which are not possible or at least not cost effective to be made by shaping ferromagnetic sheets which are originally planar.

### FIELD OF THE DISCLOSURE

The disclosure relates to a core element of a magnetic component. The core element can be, for example but not necessarily, a stator or rotor core of an axial magnetic bearing, a stator or rotor core of a combined axial and radial magnetic bearing, a transformer or filter core, or a stator or rotor core of an electric machine. Furthermore, the disclosure relates to a method for manufacturing a core element of a magnetic component.

### BACKGROUND

In many cases, a core element of a magnetic component is implemented as a laminated structure, i.e. a stacked sheet structure, so that the magnetic flux is conducted along the sheets and not through the sheets. The advantage of the laminated structure is that a changing magnetic flux causes significantly less eddy currents than in a corresponding core element made of solid steel. The core element can be, for example but not necessarily, a stator or rotor core of an axial magnetic bearing, a stator or rotor core of a radial magnetic bearing, a stator or rotor core of a combined axial and radial magnetic bearing, a transformer or filter core, a stator or rotor core of an electric machine, or a stator core of a bearingless electric machine where the stator core is used not only for torque production but also for magnetic levitation of the rotor.

An inherent drawback of a laminated structure is that it can be cumbersome to construct core elements where the ferromagnetic sheets need to be curved in mutually intersecting directions in order to achieve a situation where a magnetic flux can flow along the sheets without a need to flow through the sheets. It is straightforward to construct e.g. a stator or rotor core of a radial-flux electric machine by using planar ferromagnetic sheets that are stacked on each other in the axial direction of the electric machine. As well, it is straightforward to construct a core element for a toroidal coil by rolling an elongated ferromagnetic sheet in the same way as a tape is rolled on a roll of tape. However, it is significantly more challenging to construct e.g. a laminated stator core element for an axial magnetic bearing so that a magnetic flux does not need to flow through the ferromagnetic sheets. The stator core element of an axial magnetic bearing is usually a rotationally symmetric element that comprises an annular groove for a coil for conducting electric current. Thus, the ferromagnetic sheets of the above-mentioned core element would have to be curved in mutually intersecting directions in order to achieve a situation where the magnetic flux does not need to flow through the sheets. In many cases, it is not possible or at least it is not cost effective to make laminated core elements in which ferromagnetic sheets that are originally planar need to be shaped in complex ways.

### SUMMARY

The following presents a simplified summary in order to provide a basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

In this document, the word “geometric” when used as a prefix means a geometric concept that is not necessarily a part of any physical object. The geometric concept can be for example a geometric line or axis, a geometric plane, a non-planar geometric surface, a geometric room, or any other geometric entity that is one, two, or three dimensional.

In accordance with the invention, there is provided a new method for manufacturing a core element for a magnetic component.

A method according to the invention comprises:
producing, by three-dimensional “3D” printing, a ferromagnetic structure comprising a plurality of ferromagnetic sections where adjacent ones of the ferromagnetic sections are connected to each other with ferromagnetic isthmuses, where the ferromagnetic structure constitutes at least a part of the core element,
casting electrically insulating material into gaps between the ferromagnetic sections, and
subsequently to the casting, cutting openings in the ferromagnetic structure so that at least part of the ferromagnetic isthmuses are removed.

As the above-mentioned ferromagnetic structure is manufactured by the three-dimensional printing, it is possible to make core elements which are not possible or at least not cost effective to be made by shaping ferromagnetic sheets which are originally planar.

A method according to an exemplifying and non-limiting embodiment of the invention further comprises casting electrically insulating material into the gaps between the ferromagnetic sections. A method according to an exemplifying and non-limiting embodiment of the invention further comprises, subsequently to the casting, cutting openings in the ferromagnetic structure so that at least a part of the ferromagnetic isthmuses are removed. A method according to an exemplifying and non-limiting embodiment of the invention further comprises, subsequently to the cutting, casting electrically insulating material into the openings.

In accordance with the invention, there is provided also a new core element for a magnetic component. The core element can be, for example but not necessarily, a stator or rotor core of an axial magnetic bearing, a stator or rotor core of a radial magnetic bearing, a stator or rotor core of a combined axial and radial magnetic bearing, a transformer or filter core, a stator or rotor core of an electric machine, or a stator core of a bearingless electric machine where the stator core is used not only for torque production but also for magnetic levitation of the rotor.

A core element according to the invention comprises a plurality of ferromagnetic sections for conducting magnetic flux, wherein gaps between the ferromagnetic sections are filled with electrically insulating solid material and adjacent ones of the gaps are connected to each other via openings through the ferromagnetic sections, the openings being filled with electrically insulating solid material.

A magnetic component according to the invention comprises a core element according to the invention and at least one winding for conducting electric current so as to generate a magnetic flux conducted by the core element.

A number of exemplifying and non-limiting embodiments of the invention are described in accompanied dependent claims.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of un-recited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF THE FIGURES

Exemplifying and non-limiting embodiments of the invention and their advantages are explained in greater detail below in the sense of examples and with reference to the accompanying drawings, in which:

FIG. 1 shows a flowchart illustrating methods according to exemplifying and non-limiting embodiments of the invention for manufacturing a core element for a magnetic component.

FIGS. 2a, 2b, 2c, 2d, 2e, and 2f illustrate a method for manufacturing a core element according to an exemplifying and non-limiting embodiment of the invention.

FIGS. 3a and 3b illustrate a detail of a core element according to an exemplifying and non-limiting embodiment of the invention,

FIGS. 4a and 4b illustrate core elements according to an exemplifying and non-limiting embodiment of the invention,

FIGS. 5a, 5b, and 5c illustrate core elements according to an exemplifying and non-limiting embodiment of the invention,

FIGS. 6a and 6b illustrate a core element according to an exemplifying and non-limiting embodiment of the invention,

FIGS. 7a and 7b illustrate a core element according to an exemplifying and non-limiting embodiment of the invention, and

FIGS. 8a and 8b illustrate core elements according to an exemplifying and non-limiting embodiment of the invention.

### DESCRIPTION OF EXEMPLIFYING AND NON-LIMITING EMBODIMENTS

The specific examples provided in the description given below should not be construed as limiting the scope and/or the applicability of the appended claims. Lists and groups of examples provided in the description given below are not exhaustive unless otherwise explicitly stated.

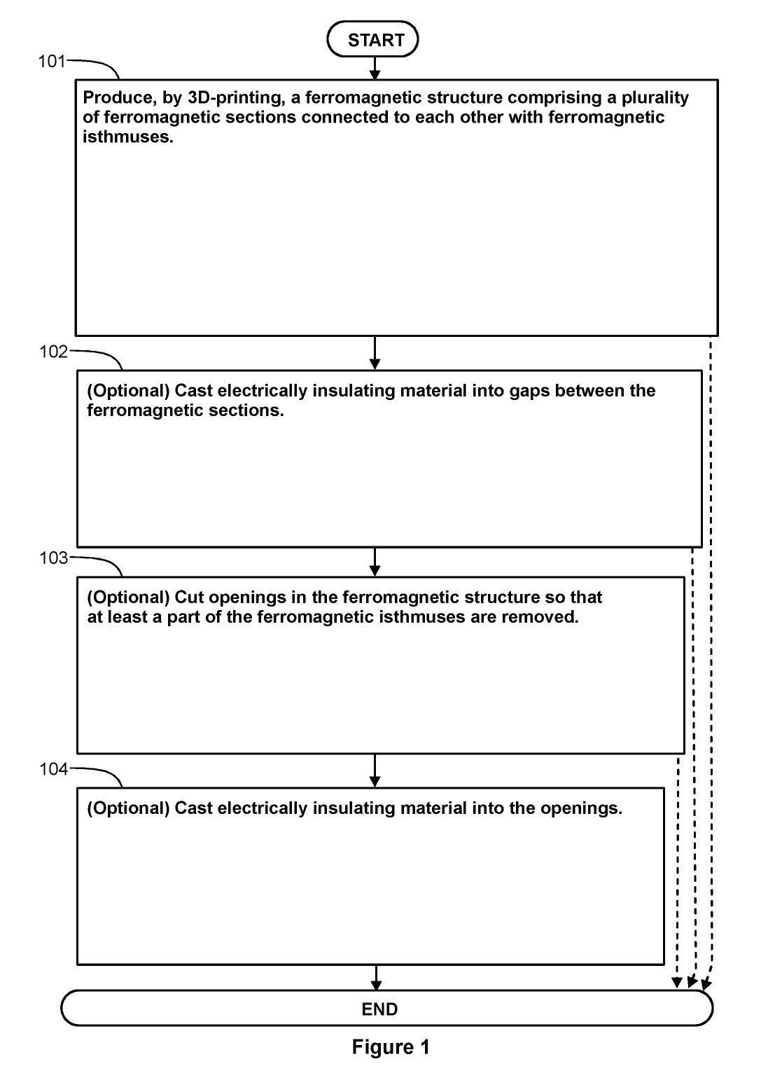

FIG. 1 shows a flowchart illustrating methods according to exemplifying and non-limiting embodiments of the invention for manufacturing a core element for a magnetic component. An action 101 of the method comprises producing a ferromagnetic structure by three-dimensional “3D” printing. The ferromagnetic structure comprises a plurality of ferromagnetic sections where adjacent ones of the ferromagnetic sections are connected to each other with ferromagnetic isthmuses keeping the adjacent ones of the ferromagnetic sections a distance apart from each other. The ferromagnetic isthmuses and the ferromagnetic sections may constitute a single piece of ferromagnetic material, e.g. steel, so that detaching the ferromagnetic isthmuses from the ferromagnetic sections requires material breaking. The ferromagnetic sections can constitute e.g. a stack of ferromagnetic sheets or a bundle of ferromagnetic filaments. The fact that the ferromagnetic sections are kept apart from each other reduces eddy currents caused by a changing magnetic flux in the ferromagnetic structure.

In a method according to an exemplifying and non-limiting embodiment of the invention, the above-mentioned ferromagnetic structure constitutes the core element. In this exemplifying case, the gaps between the ferromagnetic sections are filled by ambient air or by other gas or liquid surrounding the core element.

A method according to an exemplifying and non-limiting embodiment of the invention further comprises an optional action 102 in which first electrically insulating material is cast into the gaps between the ferromagnetic sections. The first electrically insulating material filling the gaps improves the mechanical strength of the core element. The first electrically insulating material can be for example resin or plastics.

A method according to an exemplifying and non-limiting embodiment of the invention further comprises an optional action 103 in which openings are cut in the ferromagnetic structure so that at least a part of the ferromagnetic isthmuses are removed. This further reduces eddy currents caused by a changing magnetic flux in the core element.

A method according to an exemplifying and non-limiting embodiment of the invention further comprises an optional action 104 in which second electrically insulating material is cast into the above-mentioned openings. The second electrically insulating material filling the openings improves the mechanical strength of the core element. The second electrically insulating material can be for example resin or plastics. The second electrically insulating material can be the same as the above-mentioned first electrically insulating material.

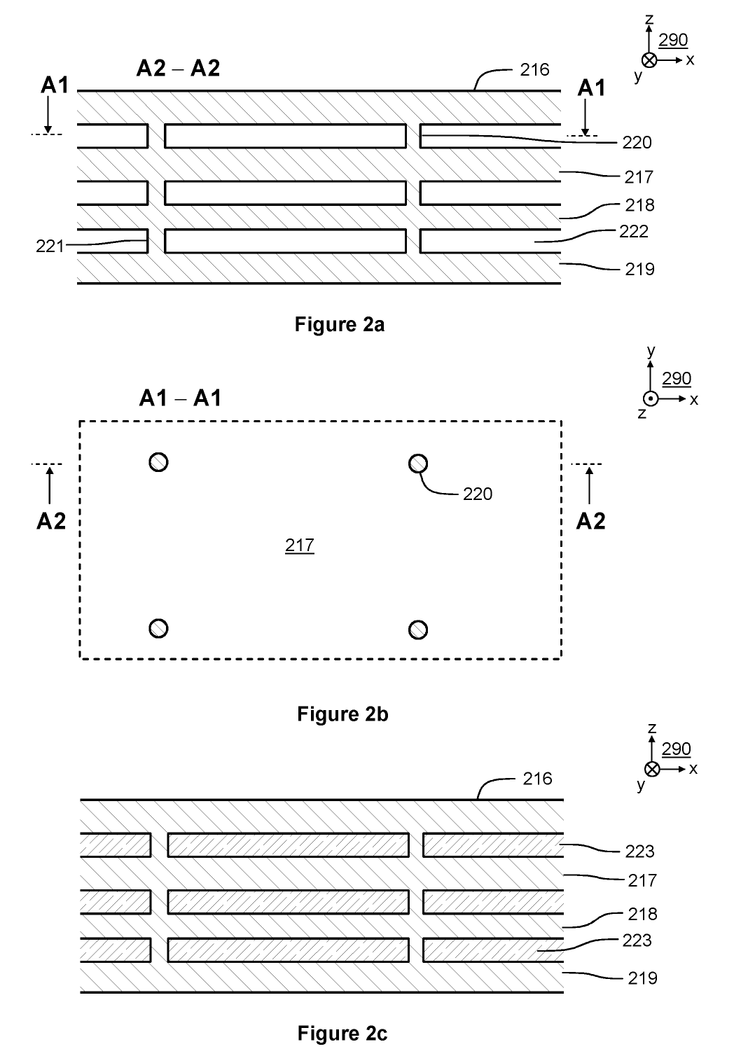

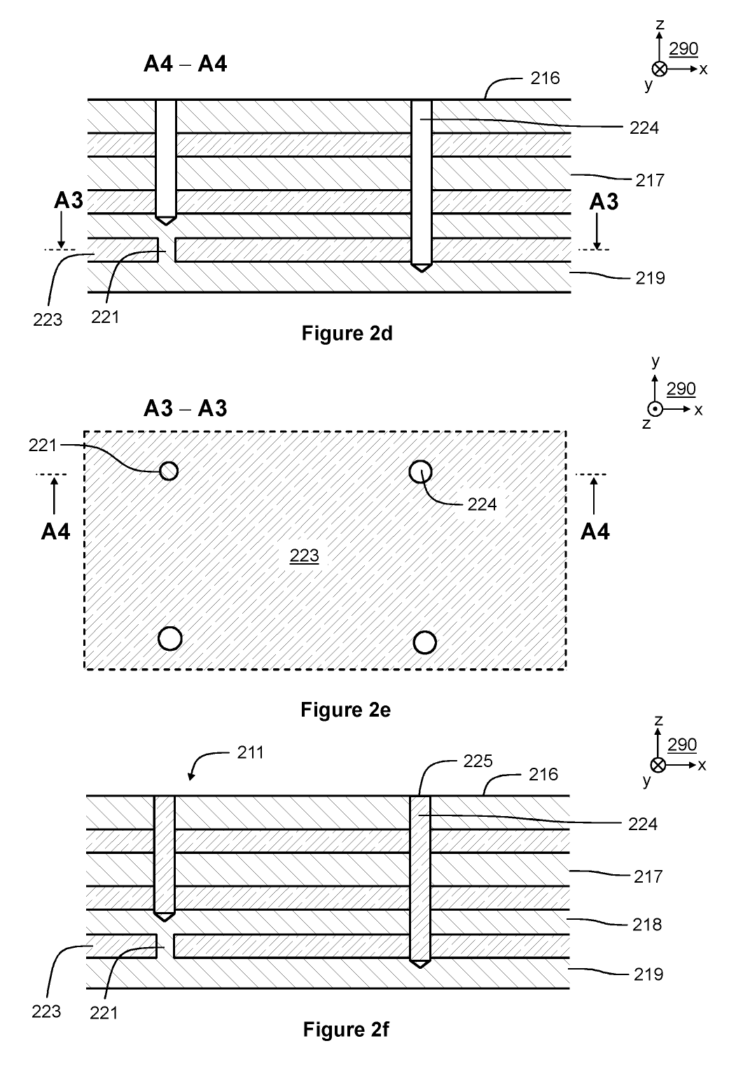

FIGS. 2a, 2b, 2c, 2d, 2e, and 2f illustrate a method for manufacturing a core element in an exemplifying case where the method comprises the above-mentioned actions 101-104 shown in the flowchart of FIG. 1. The resulting core element is denoted with a reference 211 in FIG. 2f. FIGS. 2a and 2b illustrate the ferromagnetic structure made by the 3D printing in the action 101. FIG. 2a shows a section view of a part of the ferromagnetic structure so that the section is taken along a geometric line A2-A2 shown in FIG. 2b and the geometric section plane is parallel with the xz-plane of a coordinate system 290. FIG. 2b shows a section view so that the section is taken along a geometric line A1-A1 shown in FIG. 2a and the geometric section plane is parallel with the xy-plane of the coordinate system 290. The ferromagnetic structure comprises a plurality of ferromagnetic sections that are connected to each other with ferromagnetic isthmuses that keep the adjacent ones of the ferromagnetic sections a distance apart from each other. In FIG. 2a, four of the ferromagnetic sections are denoted with references 216, 217, 218, and 219 and two of the ferromagnetic isthmuses are denoted with references 220 and 221. FIG. 2b shows a part of the ferromagnetic section 217 and cross-sections of four of the ferromagnetic isthmuses. As can be seen from FIGS. 2a and 2b, the ferromagnetic sections are ferromagnetic sheets that are kept apart from each other by the ferromagnetic isthmuses so that there are gaps between adjacent ones of the ferromagnetic sheets. In FIG. 2a, one of the gaps is denoted with a reference 222.

FIG. 2c illustrates the result of the action 102 shown in the flowchart of FIG. 1. FIG. 2c shows a section view in the same way as FIG. 2a. In FIG. 2c, the first electrically insulating material which has been cast into the gaps between the ferromagnetic sections is denoted with a reference 223.

FIGS. 2d and 2e illustrate the result of the action 103 shown in the flowchart of FIG. 1. FIG. 2d shows a view of a section taken along a geometric line A4-A4 shown in FIG. 2e, where the geometric section plane is parallel with the xz-plane of the coordinate system 290. FIG. 2e shows a view of a section taken along a geometric line A3-A3 shown in FIG. 2d, where the geometric section plane is parallel with the xy-plane of the coordinate system 290.

In FIGS. 2d and 2e, one of the openings that have been cut in the ferromagnetic structure is denoted with a reference 224. In this exemplifying case, as can be seen from FIGS. 2a and 2d, the ferromagnetic isthmus 220 has been removed by cutting whereas the ferromagnetic isthmus 221 has been left unremoved. The openings can be cut for example by drilling, laser cutting, water jet cutting, and/or with any other suitable cutting method.

FIG. 2f illustrates the result of the action 104 shown in the flowchart of FIG. 1. FIG. 2f shows a section view in the same way as FIG. 2d. In FIG. 2f, the second electrically insulating material which has been cast into the above-mentioned openings is denoted with a reference 225. The second electrically insulating material 225 cast into the cut openings can be the same as the first electrically insulating material 223 that has been cast into the gaps between the ferromagnetic sections.

For the sake of illustrative purposes, the z-directional widths of the gaps between the ferromagnetic sheets are exaggerated in FIGS. 2a-2f with respect to the thicknesses of the ferromagnetic sheets. In practical cases, the thicknesses of the ferromagnetic sheets are advantageously significantly greater than the widths of the gaps between the ferromagnetic sheets. Additionally, the thickness of the gaps between the ferromagnetic sheets and/or the thickness of the ferromagnetic sheets can vary at different points on the cross-section plane and at different cross-section planes.

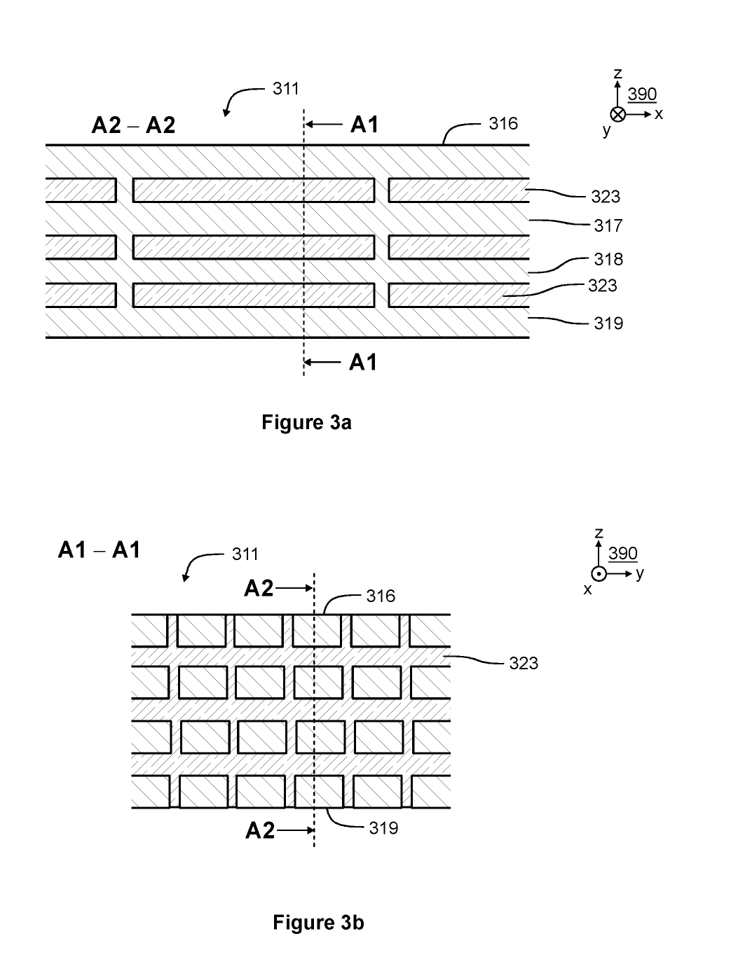

FIGS. 3a and 3b illustrate a detail of a core element 311 according to an exemplifying and non-limiting embodiment of the invention. FIG. 3a shows a section view of a part of the core element 311 so that the section is taken along a geometric line A2-A2 shown in FIG. 3b and the geometric section plane is parallel with the xz-plane of a coordinate system 390. FIG. 3b shows a section view so that the section is taken along a geometric line A1-A1 shown in FIG. 3a and the geometric section plane is parallel with the yz-plane of the coordinate system 390. The ferromagnetic structure of the core element 311 comprises a plurality of ferromagnetic sections that are connected to each other with ferromagnetic isthmuses arranged to keep the adjacent ones of the ferromagnetic sections a distance apart from each other. In FIG. 3a, four of the ferromagnetic sections are denoted with references 316, 317, 318, and 319. In this exemplifying case, the ferromagnetic sections are ferromagnetic filaments arranged to constitute a bundle of filaments. The gaps between the ferromagnetic filaments are filled with electrically insulating material 323. The ferromagnetic filaments are capable conducting a magnetic flux along the ferromagnetic filaments. The ferromagnetic filaments may have curved shapes for implementing core elements having desired shapes. Furthermore, the cross-sectional area and/or the cross-sectional shape of a ferromagnetic filament may vary along the longitudinal direction of the ferromagnetic filament under consideration. For the sake of illustrative purposes, the y- and z-directional widths of the gaps between the ferromagnetic filaments are exaggerated in FIGS. 3a and 3b with respect to the y- and z-directional thicknesses of the ferromagnetic filaments. In practical cases, the thicknesses of the ferromagnetic filaments are advantageously significantly greater than the widths of the gaps between the ferromagnetic filaments.

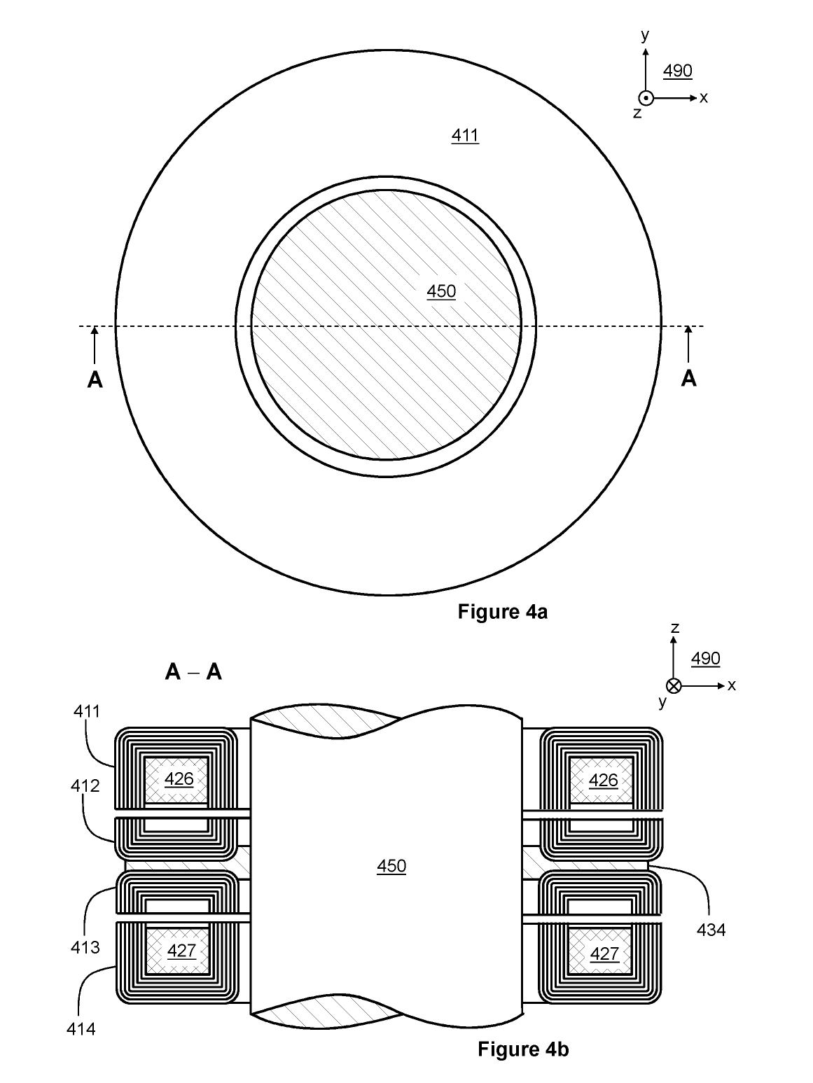

Core elements that are manufactured by the above-illustrated methods can be used in many different applications. Some exemplifying and non-limiting applications are presented below with reference to FIGS. 4a, 4b, 5a, 5b, 5c, 6a, 6b, 7a, and 7b. It is, however, to be noted that core elements manufactured by the above-illustrated methods can be used in many other applications, too.

FIGS. 4a and 4b illustrate core elements 411, 412, 413, and 414 according to an exemplifying and non-limiting embodiment of the invention. In this exemplifying case, the core elements 411 and 414 constitute a stator core of an axial magnetic bearing and the core elements 412 and 413 constitute a rotor core of the axial magnetic bearing. The axial direction of the axial magnetic bearing is parallel with the z-axis of a coordinate system 490. FIG. 4b shows a section view of the axial magnetic bearing. The section is taken along a geometric line A-A shown in FIG. 4a and the geometric section plane is parallel with the xz-plane of the coordinate system 490. As can be seen from FIG. 4b, the ferromagnetic sections of the core elements 411-414 are rotationally symmetric ferromagnetic sheets which have substantially U-shaped cross-sections on geometric planes which coincide with the geometric rotational axis of a shaft 450. The core elements 412 and 413 are connected to the shaft 450 with the aid of a disc 434. The axial magnetic bearing comprises annular windings 426 and 427 having coil turns surrounding the shaft 450. As can be understood from FIG. 4b, the magnetic fluxes generated by circumferential electric currents flowing in the annular windings 426 and 427 can flow along the above-mentioned ferromagnetic sheets and the magnetic fluxes do not need to flow through the ferromagnetic sheets. Correspondingly, the magnetic fluxes do not need to substantially flow through solid iron or other materials separated from, and being in a different construction than, the above-mentioned ferromagnetic sheets.

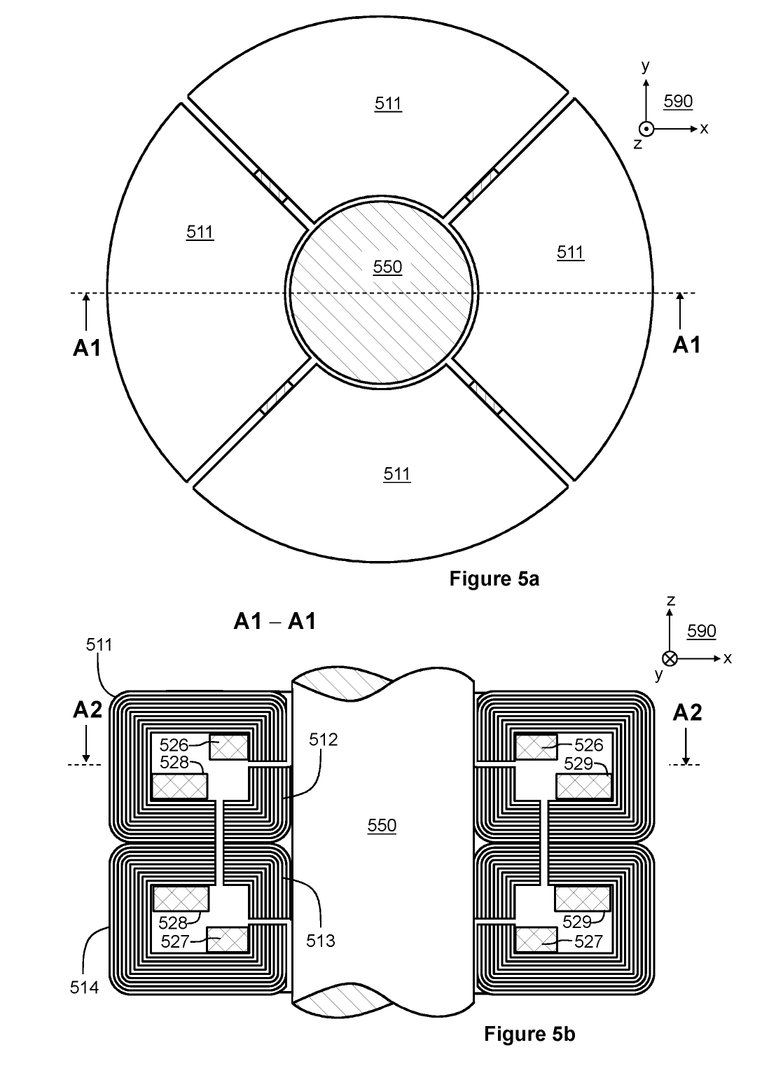

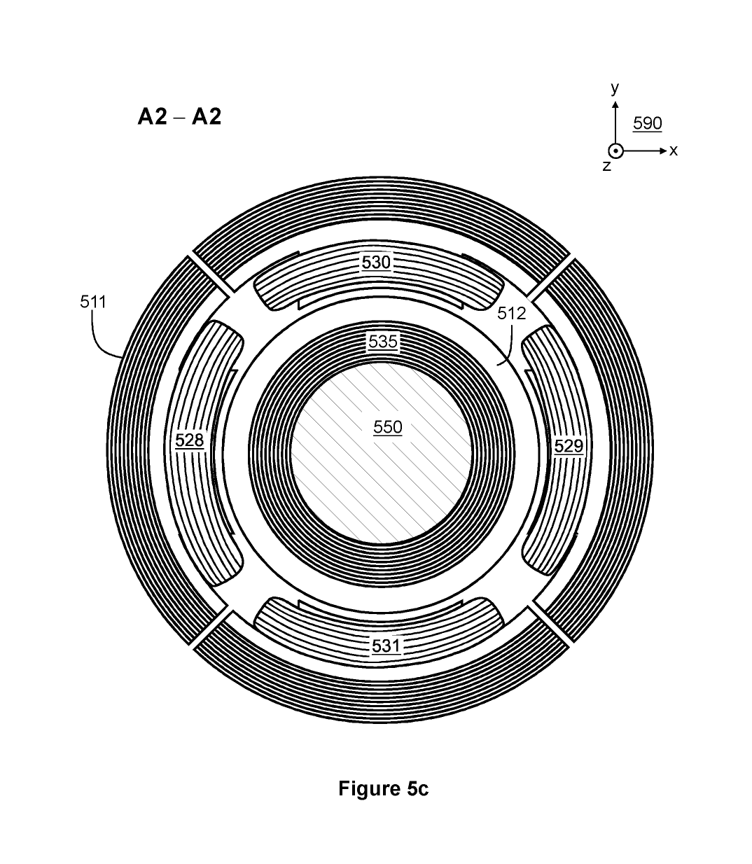

FIGS. 5a, 5b, and 5c illustrate core elements 511, 512, 513, and 514 according to an exemplifying and non-limiting embodiment of the invention. In this exemplifying case, the core elements 511 and 514 constitute a stator core of a magnetic bearing that is a combined radial and axial magnetic bearing, and the core elements 512 and 513 constitute a rotor core of the magnetic bearing. The core elements 512 and 513 are attached on a shaft 550. The axial direction of the magnetic bearing is parallel with the z-axis of a coordinate system 590. FIG. 5b shows a section view of the magnetic bearing so that the section is taken along a geometric line A1-A1 shown in FIG. 5a and the geometric section plane is parallel with the xz-plane of the coordinate system 590. FIG. 5c shows a section view of the magnetic bearing so that the section is taken along a geometric line A2-A2 shown in FIG. 5b and the geometric section plane is parallel with the xy-plane of the coordinate system 590. In FIG. 5c, an axially directed air-gap surface of the core element 512 is denoted with a reference 535.

As can be seen from FIGS. 5b and 5c, the ferromagnetic sections of the core elements 512 and 513 of the rotor side are rotationally symmetric ferromagnetic sheets which have substantially L-shaped cross-sections on geometric planes which coincide with the geometric rotational axis of the shaft 550. As can be seen from FIGS. 5b and 5c, the ferromagnetic sections of the core elements 511 and 514 of the stator side are ferromagnetic sheets that are otherwise rotationally symmetric except that the core elements 511 and 514 are segmented into four segments and that the core elements 511 and 514 comprise radially directed pole-portions for pole windings 528, 529, 530, and 531. It is also possible that the number of segments of the kind mentioned above is different from four. For example, the number of the segments can be three, six, eight, or some other suitable number. The pole windings 528-531 are suitable for directing radial magnetic forces to the core elements 512 and 513 of the rotor side. The magnetic bearing comprises annular windings 526 and 527 having coil turns surrounding the shaft 550. The annular windings 526 and 527 are suitable for directing axial magnetic forces to the core elements 512 and 513 of the rotor side. As can be understood from FIGS. 5b and 5c, the magnetic fluxes generated by circumferential electric currents flowing in the annular windings 526 and 527 can flow along the ferromagnetic sheets of the core elements 511-514 and the magnetic fluxes do not need to flow through the ferromagnetic sheets. Correspondingly, the magnetic fluxes generated by electric currents flowing in the pole windings 528-531 can flow along the ferromagnetic sheets of the core elements 511-514 and the magnetic fluxes do not need to flow through the ferromagnetic sheets. It is worth noting that the above-mentioned annular windings 526 and 527 are not the only possible choice for directing axial magnetic forces to the core elements 512 and 513 of the rotor side. For example, the annular windings 526 and 527 can be replaced with a combination of segment-specific windings each being wound around one segment of the respective core element so that the segment-specific windings protrude through the gaps between adjacent segments.

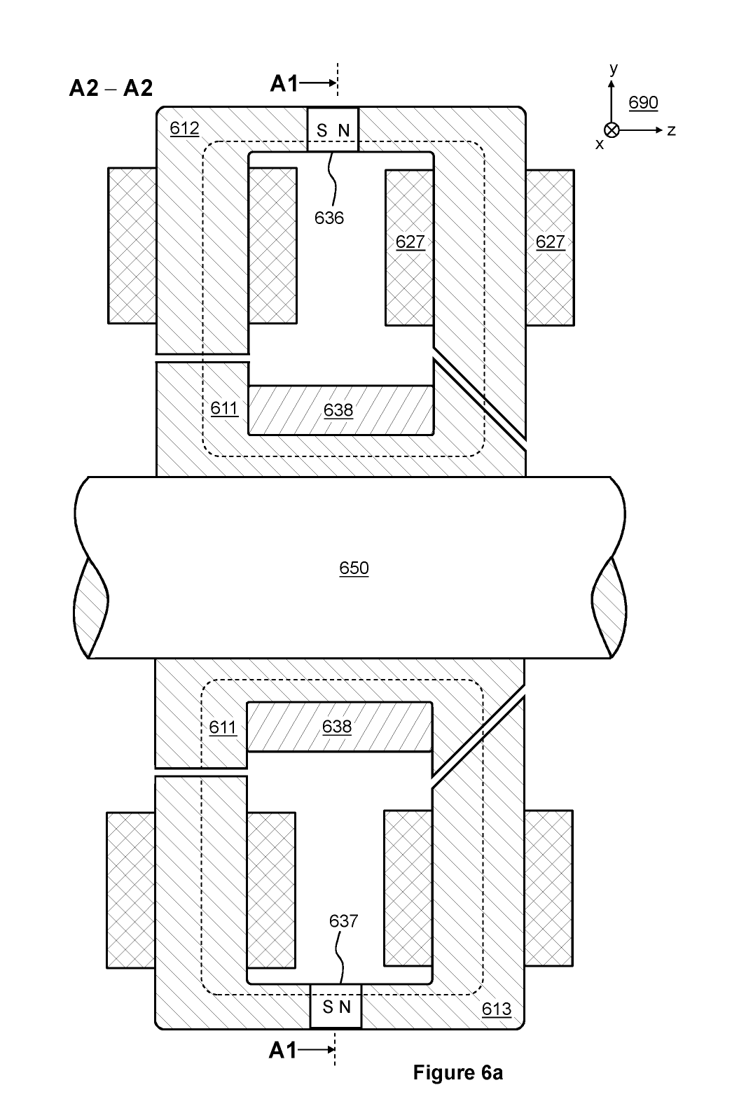

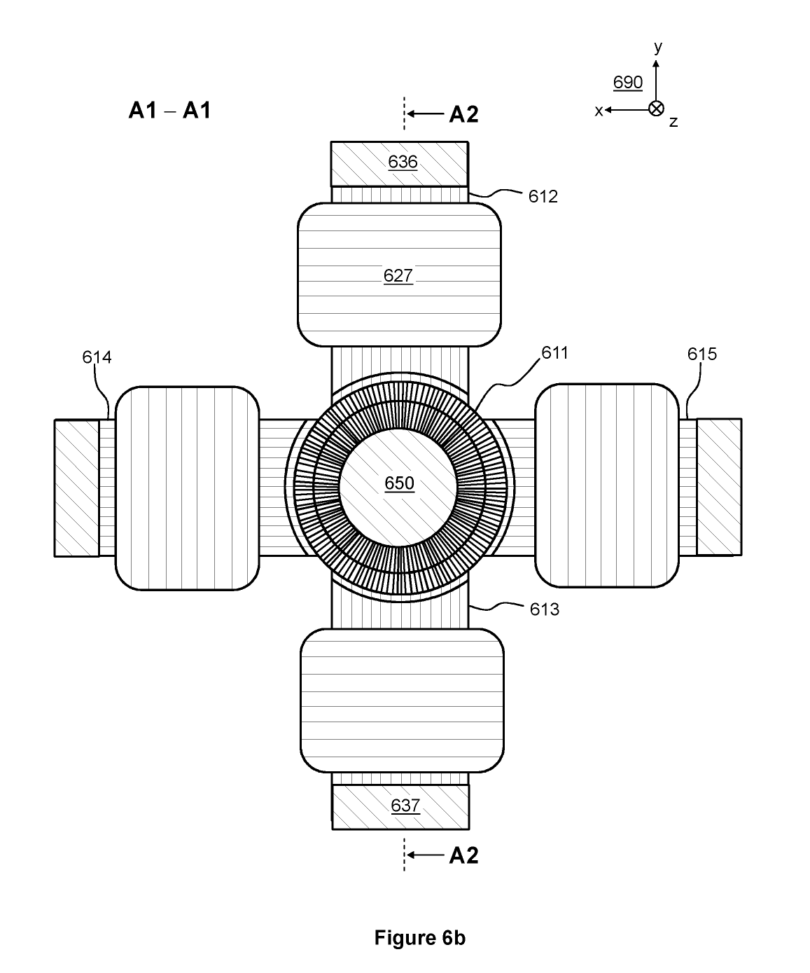

FIGS. 6a and 6b illustrate a core element 611 according to an exemplifying and non-limiting embodiment of the invention. In this exemplifying case, the core element 611 constitutes a rotor core of a magnetic bearing that is a combined radial and axial magnetic bearing. The axial direction of the magnetic bearing is parallel with the z-axis of a coordinate system 690. FIG. 6a shows a section view of the magnetic bearing so that the section is taken along a geometric line A2-A2 shown in FIG. 6b and the geometric section plane is parallel with the yz-plane of the coordinate system 690. FIG. 6b shows a section view of the magnetic bearing so that the section is taken along a geometric line A1-A1 shown in FIG. 6a and the geometric section plane is parallel with the xy-plane of the coordinate system 690. The magnetic bearing is capable of directing an axial magnetic force to the core element 611 only in the positive z-direction of the coordinate system 690. Thus, there is a need for an arrangement such that an axial force is directed to the core element 611 in the negative z-direction, too.

The magnetic bearing comprises windings for generating magnetic fluxes that flow in stator core elements 612, 613, 614, and 615 of the magnetic bearing and in the core element 611 of the rotor side. In FIGS. 6a and 6b, one of the windings is denoted with a reference 627. The stator core elements 612-615 can be constructed for example by stacking electrically insulated planar ferromagnetic sheets on each other. It is, however, also possible that the stator core elements 612-615 are manufactured by a method according to an exemplifying and non-limiting embodiment of the invention. The magnetic bearing comprises permanent magnets for generating bias magnetic fluxes for linearizing the control of the magnetic bearing. In FIGS. 6a and 6b, two of the permanent magnets are denoted with references 636 and 637. In FIG. 6a, two of the bias magnetic fluxes are depicted with dashed lines.

As illustrated in FIG. 6b, the ferromagnetic sections of the core element 611 are ferromagnetic sheets which are parallel with geometric planes coinciding with the geometric rotation axis of a shaft 650. The ferromagnetic sheets of the core element 611 are wedge-shaped so that the thicknesses of the ferromagnetic sheets decrease towards the geometric rotation axis of the shaft 650. As can be understood on the basis of FIGS. 6a and 6b, the magnetic fluxes generated by the permanent magnets and by electric currents flowing in the windings can flow along the ferromagnetic sheets of the stator core elements 612-615 and along the ferromagnetic sheets of the core element 611 of the rotor side, and the magnetic fluxes do not need to flow through the ferromagnetic sheets. The core element 611 can be provided with a support ring so as to improve the mechanical strength of the core element. In FIG. 6a, the support ring is denoted with a reference 638. For the sake of clarity, the support ring is not shown in FIG. 6b. The support ring 638 may comprise for example metal, glass fiber reinforced resin or plastic, carbon fiber reinforced resin or plastic, or some other suitable material capable of withstanding mechanical stress. In the exemplifying case illustrated in FIGS. 6a and 6b, the number of the stator core elements 612-615 is four but it is also possible that the number of corresponding stator core elements is for example three, six, or some other suitable number.

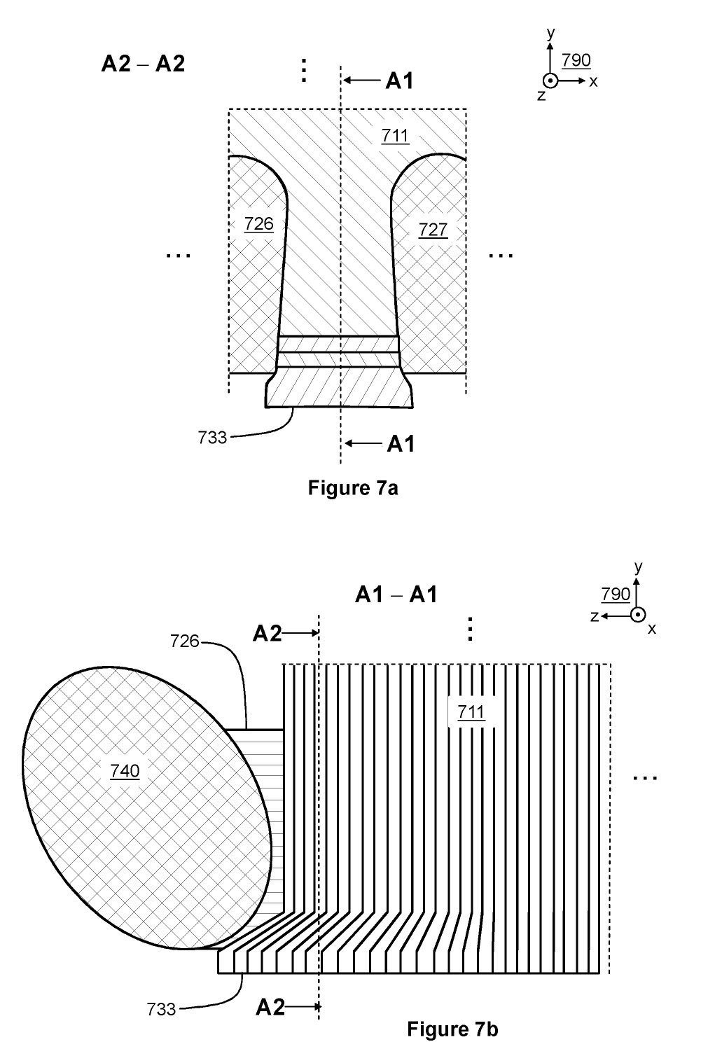

FIGS. 7a and 7b illustrate a detail of a core element 711 according to an exemplifying and non-limiting embodiment of the invention. In this exemplifying case, the core element 711 is a stator core of a radial-flux electric machine. The axial direction of the radial-flux electric machine is parallel with the z-axis of a coordinate system 790. FIG. 7a shows a section view of a part of the core element 711 so that the section is taken along a geometric line A2-A2 shown in FIG. 7b and the geometric section plane is parallel with the xy-plane of the coordinate system 790. FIG. 7b shows a section view of the above-mentioned part of the core element 711 so that the section is taken along a geometric line A1-A1 shown in FIG. 7a and the geometric section plane is parallel with the yz-plane of the coordinate system 790. The core element 711 comprises teeth for conducting magnetic fluxes in radial directions and a yoke connecting the teeth to each other. Adjacent ones of the teeth constitute grooves for coil sides of the windings of the electric machine. FIG. 7a shows a section view of one of the above-mentioned teeth. Furthermore, FIG. 7a shows section views of parts of coil sides 726 and 727. FIG. 7b shows a section view of the above-mentioned tooth, a part of the coil side 726, and a section view of an end-winding 740.

As illustrated in FIG. 7b, the ferromagnetic sections of the core element 711 are ferromagnetic sheets which are stacked in the axial direction of the electric machine. As illustrated in FIG. 7b, the ferromagnetic sheets which constitute axial end-regions of the core element 711 are thicker on the tooth-tip regions 733 of the teeth of the core element 711 than elsewhere within the core element so that tooth-tips of the teeth protrude axially at the axial end-regions of the core element. Thus, the tooth-tips are extended not only circumferentially as shown in FIG. 7a but also in the axial directions as illustrated in FIG. 7b. Thus, the magnetic flux density in the air-gap where the magnetic flux harmonics are strongest can be reduced. As a corollary, the iron losses taking place in the tooth-tips and other areas in the vicinity of the air-gap can be reduced.

The principle described above with reference to FIGS. 7a and 7b is as well applicable in a rotor core of a radial-flux electric machine.

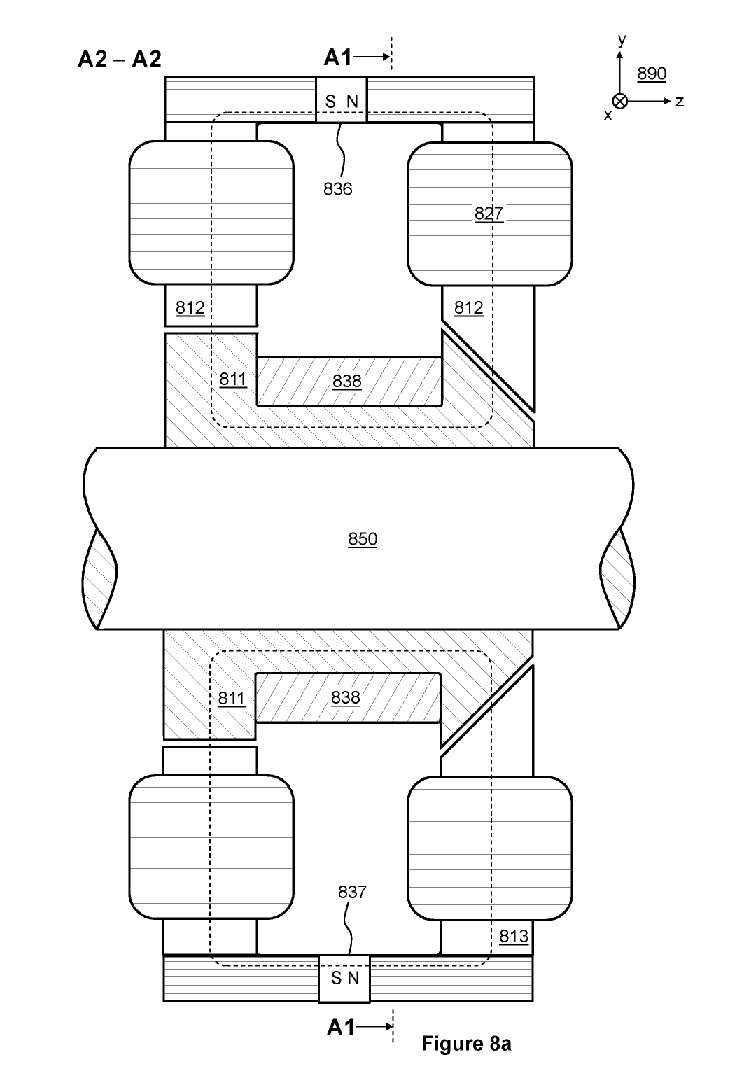

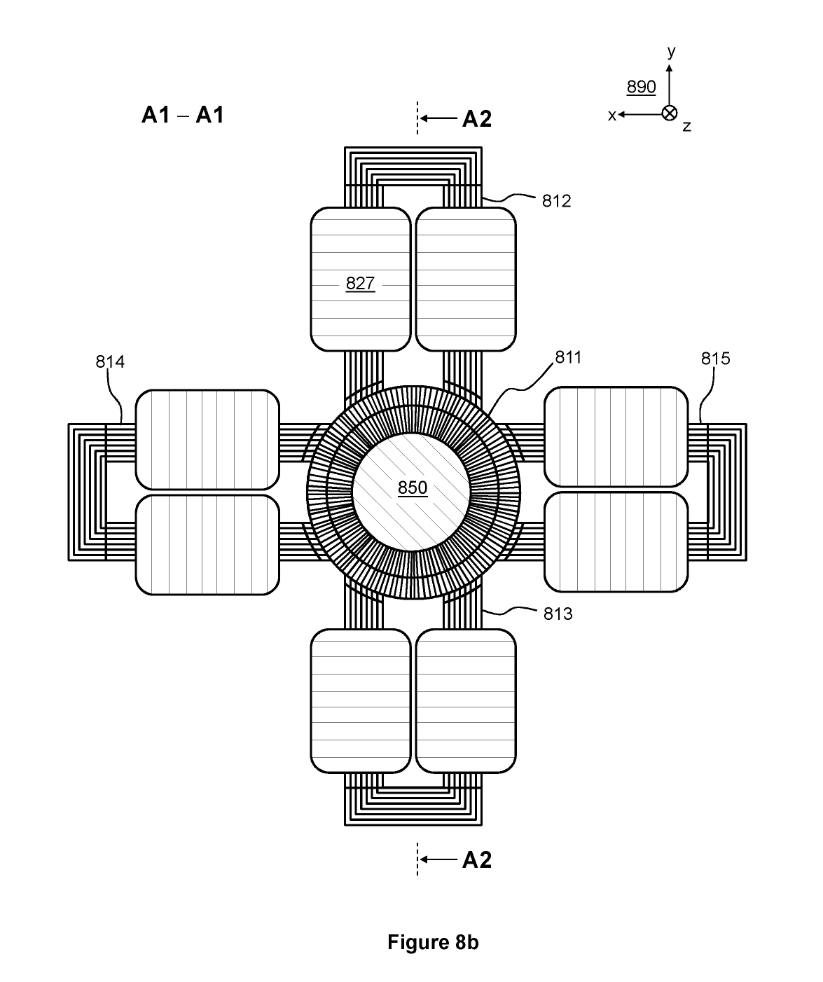

FIGS. 8a and 8b illustrate core elements 812, 813, 814, and 815 according to an exemplifying and non-limiting embodiment of the invention. In this exemplifying case, the core elements 812-815 constitute a stator core of a magnetic bearing that is a combined radial and axial magnetic bearing. A rotor core element 811 can be similar to the core element 611 illustrated in FIGS. 6a and 6b. The axial direction of the magnetic bearing is parallel with the z-axis of a coordinate system 890. FIG. 8a shows a section view of the magnetic bearing so that the section is taken along a geometric line A2-A2 shown in FIG. 8b and the geometric section plane is parallel with the yz-plane of the coordinate system 890. FIG. 8b shows a section view of the magnetic bearing so that the section is taken along a geometric line A1-A1 shown in FIG. 8a and the geometric section plane is parallel with the xy-plane of the coordinate system 890. The magnetic bearing is capable of directing an axial magnetic force to the rotor core element 811 only in the positive z-direction of the coordinate system 890. Thus, there is a need for an arrangement such that an axial force is directed to the rotor core element 811 in the negative z-direction, too.

The magnetic bearing comprises windings for generating magnetic fluxes that flow in the core elements 812-815 of the magnetic bearing and in the rotor core element 811. In FIGS. 8a and 8b, one of the windings is denoted with a reference 827. The magnetic bearing further comprises permanent magnets for generating bias magnetic fluxes for linearizing the control of the magnetic bearing. In FIG. 8a two of the permanent magnets are denoted with references 836 and 837. In FIG. 8a, two of the bias magnetic fluxes are depicted with dashed lines.

As illustrated in FIG. 8b, the ferromagnetic sections of the core elements 812-815 are ferromagnetic sheets which are substantially U-shaped when seen along the z-axis of the coordinate system 890. The magnetic flux components created by electric currents of the windings flow mostly through the radial paths of the yoke sections of the core elements 812-815 because of the higher reluctance of the permanent magnets on the axial paths of the yoke sections of the core elements 812-815. The rotor core element 811 can be provided with a support ring so as to improve the mechanical strength of the core element. In FIG. 8a, the support ring is denoted with a reference 838. For the sake of clarity, the support ring is not shown in FIG. 8b. The support ring 838 may comprise for example metal, glass fiber reinforced resin or plastic, carbon fiber reinforced resin or plastic, or some other suitable material capable of withstanding mechanical stress. In the exemplifying case illustrated in FIGS. 8a and 8b, the number of the core elements 812-815 is four but it is also possible that the number of corresponding core elements is for example three, six, or some other suitable number.

The specific examples provided in the description given above should not be construed as limiting the scope and/or the applicability of the appended claims. Lists and groups of examples provided in the description given above are not exhaustive unless otherwise explicitly stated.

1-14. (canceled)

15. A method for manufacturing a core element for a magnetic component, the method comprising:
producing, by three-dimensional printing, a ferromagnetic structure comprising a plurality of ferromagnetic sections where adjacent ones of the ferromagnetic sections are connected to each other with ferromagnetic isthmuses, the ferromagnetic structure constituting at least a part of the core element, and
casting first electrically insulating material into gaps between the ferromagnetic sections,
wherein the method further comprises, subsequently to the casting, cutting openings in the ferromagnetic structure so that at least part of the ferromagnetic isthmuses are removed.

16. A method according to claim 15, wherein the method further comprises, subsequently to the cutting, casting second electrically insulating material into the openings.

17. A core element for a magnetic component, the core element being manufactured by a method according to claim 15.

18. A core element for a magnetic component, the core element comprising a plurality of ferromagnetic sections for conducting magnetic flux, wherein gaps between the ferromagnetic sections are filled with first electrically insulating solid material and adjacent ones of the gaps are connected to each other via openings through the ferromagnetic sections, the openings being filled with second electrically insulating solid material.

19. A core element according to claim 18, wherein the ferromagnetic sections are ferromagnetic sheets for conducting the magnetic flux along the ferromagnetic sheets, the ferromagnetic sheets constituting a stack of ferromagnetic sheets so that the first electrically insulating solid material is between adjacent ones of the ferromagnetic sheets.

20. A core element according to claim 19, wherein a thickness of each ferromagnetic sheet is uniform so that the thickness of the ferromagnetic sheet is a same at each point of the sheet.

21. A core element according to claim 19, wherein at least one of the ferromagnetic sheets has different thicknesses at different points of the ferromagnetic sheet.

22. A core element according to claim 18, wherein the second electrically insulating solid material is same as the first electrically insulating solid material.

23. A core element according to claim 18, wherein the ferromagnetic sections are elongated ferromagnetic filaments for conducting the magnetic flux along the ferromagnetic filaments, the ferromagnetic filaments constituting a bundle of ferromagnetic filaments.

24. A magnetic component comprising:
a core element, and
one or more windings for conducting one or more electric currents so as to generate one or more magnetic fluxes to be conducted by the core element,
wherein the core element comprises a plurality of ferromagnetic sections for conducting magnetic flux, wherein gaps between the ferromagnetic sections are filled with first electrically insulating solid material and adjacent ones of the gaps are connected to each other via openings through the ferromagnetic sections, the openings being filled with second electrically insulating solid material.

25. A magnetic component according to claim 24, wherein:
the core element is a stator or rotor core of an electric machine,
the core element comprises grooves for coil sides of the windings,
the ferromagnetic sections are ferromagnetic sheets stacked in an axial direction of the electric machine so that the first electrically insulating solid material is between adjacent ones of the ferromagnetic sheets, and
ferromagnetic sheets constituting axial end-regions of the core element are thicker on tooth-tip regions of teeth of the core element than elsewhere within the core element so that tooth-tips of the teeth protrude axially at the axial end-regions of the core element.
